(19) United States
(12) Patent Application Publication
(10) Pub. No.: US 2018/0098100 A1
(43) Pub. Date: Apr. 5, 2018

(54) STREAMING VIDEO SYSTEM

(71) Applicant: INTERCEPT TECHNOLOGIES, INC., Newport, RI (US)

(72) Inventor: JASON TURNER, NEWPORT, RI (US)

(21) Appl. No.: 15/720,110

(22) Filed: Sep. 29, 2017

Related U.S. Application Data
(60) Provisional application No. 62/403,411, filed on Oct. 3, 2016.

(51) Int. Cl. H04N 21/2187; H04N 21/2743; H04N 21/231; H04N 21/235; H04N 21/266; H04N 21/234; H04N 21/2668; H04N 21/262; H04N 21/237; H04N 21/6405

(52) U.S. Cl. CPC H04N 21/2187; H04N 21/2743; H04N 21/23109; H04N 21/2353; H04N 21/26603; H04N 21/23412; H04N 21/2668; H04N 21/2625; H04N 21/237; H04N 21/6405; H04N 21/23418

(57) ABSTRACT

A streaming video system receives a plurality of live video streams, applies filtering, and outputs the plurality of live video streams via a plurality of social networks and/or other sites that are able to receive live streamed video.

### CROSS REFERENCE TO RELATED APPLICATIONS

The present application claims priority benefit from U.S. Provisional Patent Application No. 62/403,411, entitled “STREAMING VIDEO SYSTEM,” filed Oct. 3, 2016 (docket number 3044-001-02); which, to the extent not inconsistent with the disclosure herein, is incorporated by reference.

### SUMMARY

According to an embodiment, a streaming video system includes a streaming server (e.g., a media server) configured to receive a plurality of live video streams via respective assigned communication ports. The streaming server creates a database record that can include a unique identifier, a time of arrival, one or more hashtags, optionally a protocol, optionally an originating network, and header data data that can be determined from the arriving data stream. A metadata reader can be configured to read at least one selected from the group consisting of a whitelist inclusion, a blacklist exclusion, a geofence inclusion, a geofence exclusion, one or more hashtags, the time of arrival, the protocol, the originating network, and/or other attributes; and to respectively exclude or include corresponding video streams. A back end application server can include a video processor that decodes the video streams via a codex. The back end application server filters the plurality of live video streams. The filters can include an image analysis module configured to provide skin filtering on at least a portion of the plurality of live video streams. A timer circuit may optionally apply a delay, for example at least a seven second delay, to at least an included subset of the plurality of received live video streams.

Optionally, video streams that are selected, via data carried in the database, for restreaming without image filtering can be passed to an output stage. The included subset of the received live video streams is restreamed by an output stage as a plurality of restreamed live video streams by a restreaming server (media server) to each of a plurality of social networks and/or other sites that accept live streamed video via respective assigned second communication ports.

Optionally, a video processor inserted before or included in the output stage can superimpose or interpose an advertisement into all or a subset of the restreamed live video streams. The video processor can decode the video stream via a codex, superimpose or interpose the advertisement, re-encode the video stream via a codex, and output the live stream via the respective assigned second communication port.

### BRIEF DESCRIPTION OF THE DRAWINGS

FIGS. 1-8 depict various aspects of a streaming video system, according to embodiments.

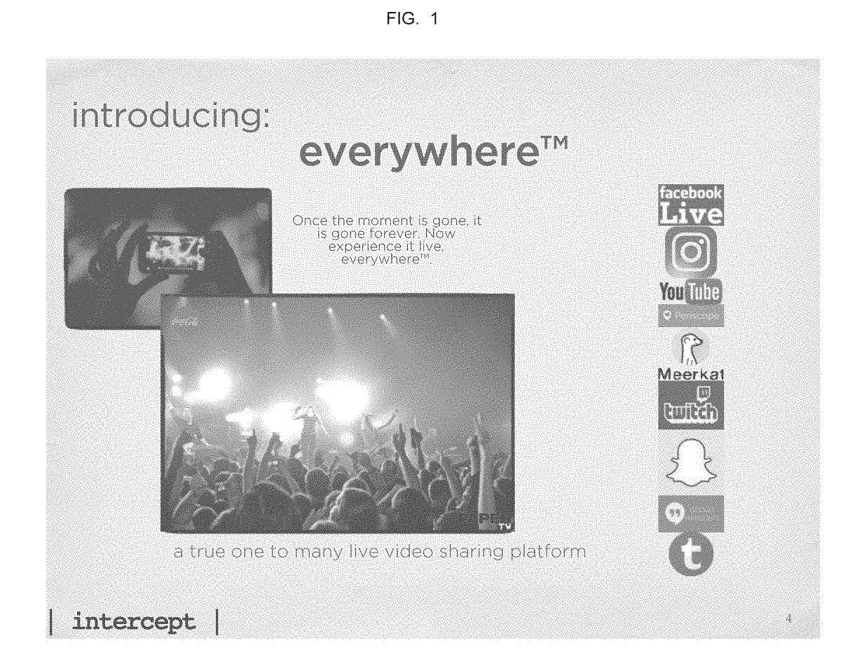

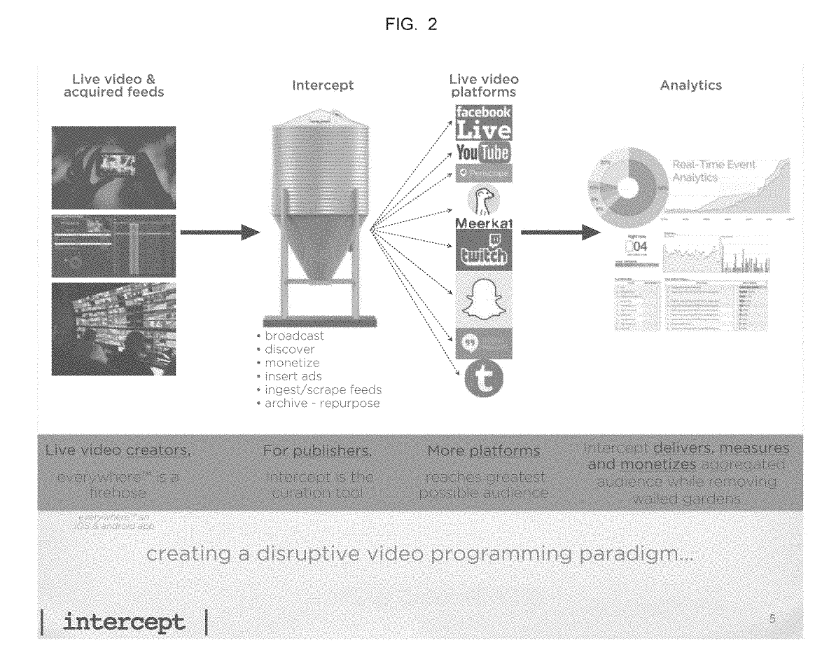

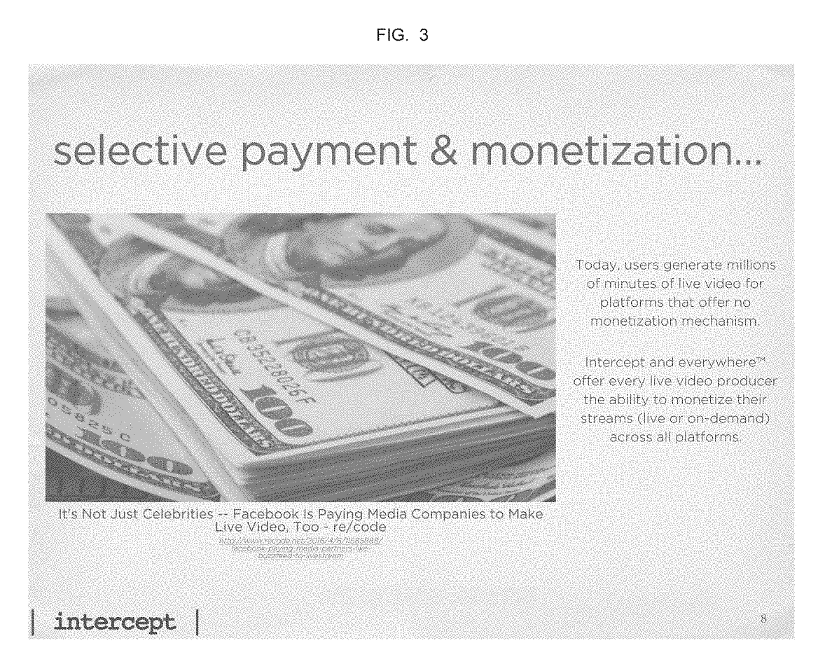

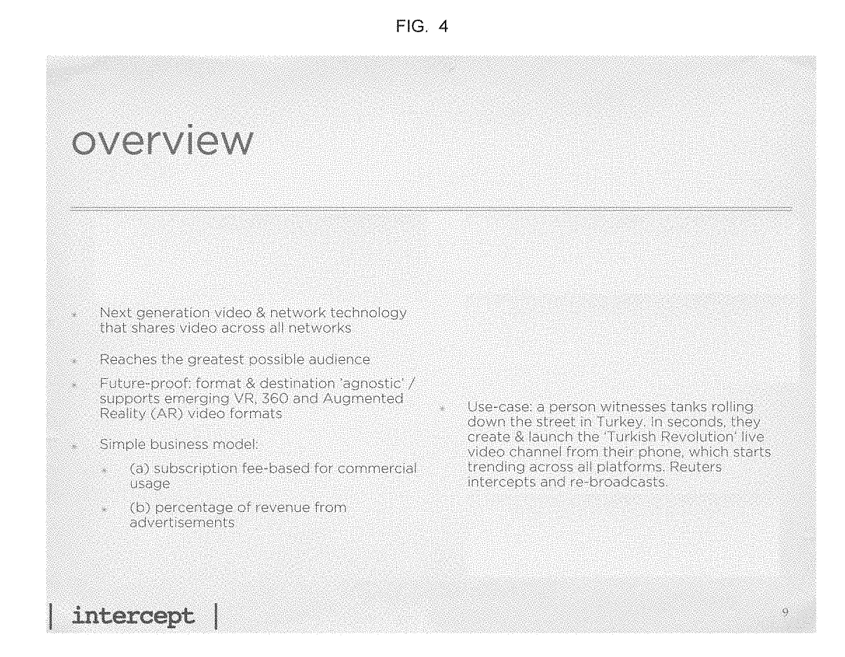

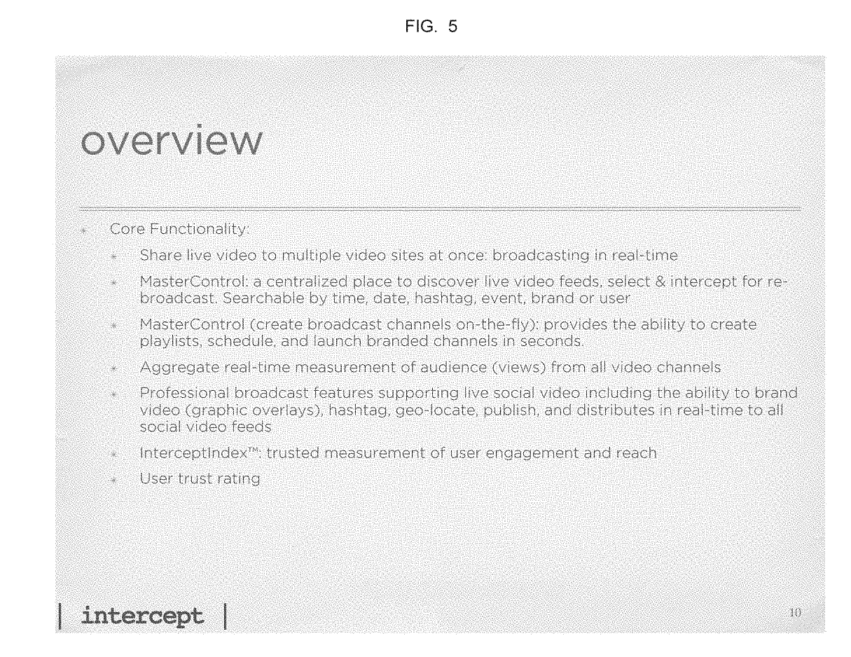

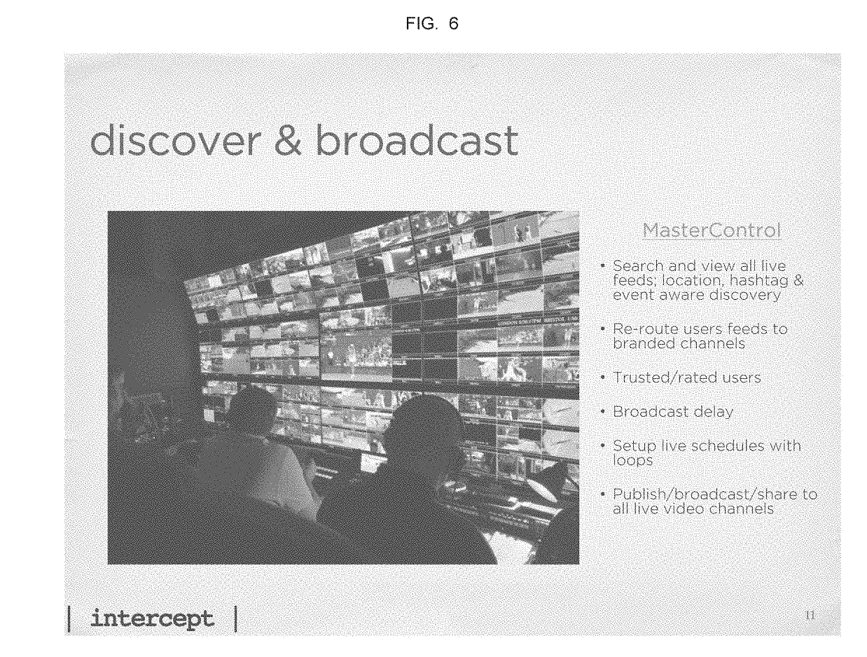

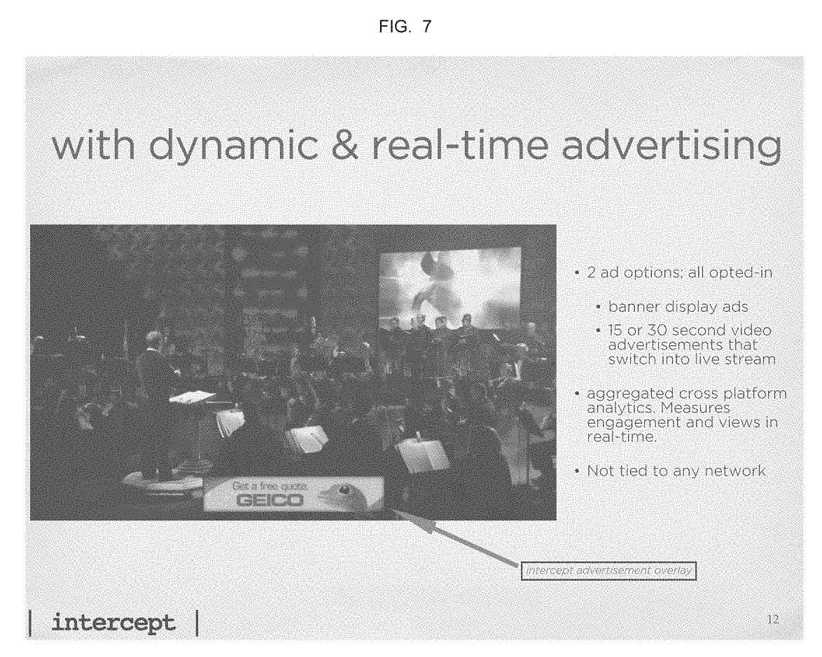

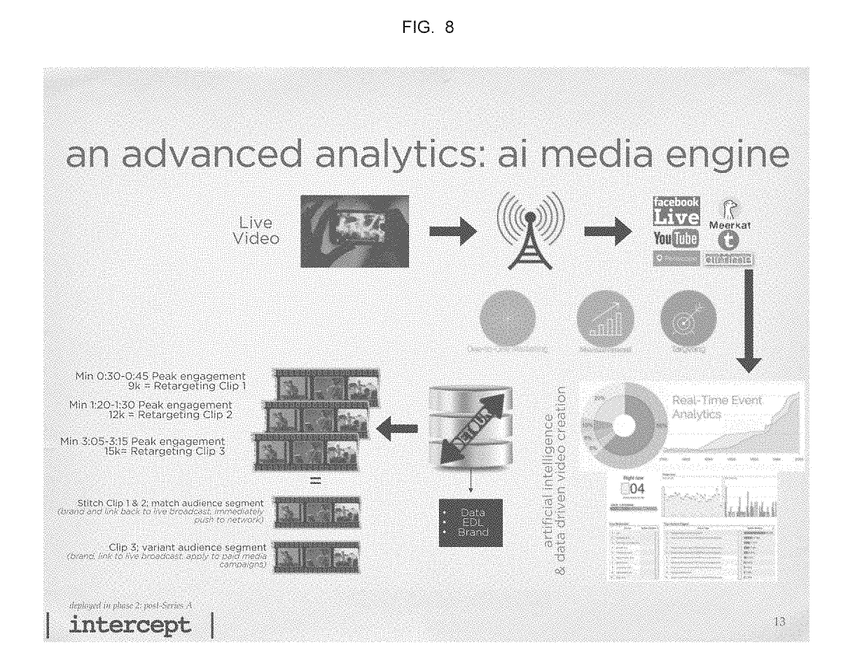

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

Aspects of the invention will be made apparent by reference to the accompanying figures.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A streaming video system comprising:
a streaming server configured to receive a plurality of live video streams via respective assigned communication ports;
a back end application server operatively coupled to the streaming server, the back end application server being configured to filter for inclusion or exclusion the plurality of received live video streams;
a timer circuit configured to apply at least a seven second delay to at least an included subset of the plurality of received live video streams; and
a restreaming server configured to restream the included subset of the received live video streams as a plurality of restreamed live video streams to each of a plurality of social networks via respective assigned second communication ports.

2. The streaming video system of claim 1, wherein the back end application server operates an image analysis module configured to provide skin filtering on at least a portion of the plurality of live video streams.

3. The streaming video system of claim 1, wherein the back end application server operates a metadata reader configured to read at least one selected from the group consisting of a whitelist inclusion, a blacklist exclusion, a geofence inclusion, a geofence exclusion, and a plurality of hashtags;

4. The streaming video system of claim 3, wherein the back end application server is configured to respectively exclude or include video streams carrying header data corresponding to filter parameters.

5. The streaming video system of claim 1, further comprising:
a video processor configured to superimpose an advertisement onto all or a subset of the restreamed live video streams as video data overwritten onto a predetermined portion of a video image carried by the live video streams.

6. The streaming video system of claim 1, further comprising:
a video processor configured to interpose an advertisement into all or a subset of the restreamed live video streams as video data inserted into the live video streams.
